(19) United States
(12) Patent Application Publication
(10) Pub. No.: US 2024/0012940 A1
(43) Pub. Date: Jan. 11, 2024

(54) SYSTEM FOR INQUIRING, GATHERING, PRIVATELY STORING, BROKERING, AND REQUESTING DELETION OF PERSONAL DATA FROM THIRD PARTY ENTITIES

(71) Applicant: Happy Warrior LLC, San Francisco, CA (US)

(72) Inventor: Geoff Evans, San Francisco, CA (US)

(21) Appl. No.: 18/472,676

(22) Filed: Sep. 22, 2023

Related U.S. Application Data
(63) Continuation of application No. 17/482,817, filed on Sep. 23, 2021, now abandoned.
(60) Provisional application No. 63/082,039, filed on Sep. 23, 2020.

(51) Int. Cl. G06F 21/62; G06N 20/00; G06Q 20/02; G06Q 30/0201

(52) U.S. Cl. CPC G06F 21/6254; G06N 20/00; G06Q 20/023; G06Q 30/0201

(57) ABSTRACT

This disclosure describes a system for managing personal information of a user that is stored on a third-party server. The system requests personal information for a user stored on a third-party server. The system receives the personal information for the user from the third-party server. The system markets the personal information for the user on behalf of the user.

This application is a continuation of U.S. patent application Ser. No. 17/482,217, filed Sep. 23, 2020, entitled “SYSTEM FOR INQUIRING, GATHERING, PRIVATELY STORING, BROKERING, AND REQUESTING DELETION OF PERSONAL DATA FROM THIRD PARTY ENTITIES”, which claims priority to U.S. Provisional Application No. 63/082,039, filed Sep. 23, 2020, each of which is incorporated by reference herein in its entirety.

### TECHNICAL FIELD

The disclosure relates to a storage and curation device for data objects.

### BACKGROUND

The California Consumer Protection Act (CCPA), which is loosely based on the European Union's General Data Protection Regulation, has allowed consumers to request access to the personal data that private companies may keep for individual consumers. For those who wish to take advantage of these regulations, consumers may obtain this personal data and/or force the private companies to delete their personal data so that the companies cannot profit off of their individual data. However, this process can generally be difficult to find and follow for ordinary consumers.

### SUMMARY

In general, the disclosure describes a process for requesting personal information stored on a third-party server and marketing the personal information on behalf of the user. The techniques described herein may automatically retrieve the personal information from the third-party server or may output instructions for the user to retrieve the information themselves. The techniques described herein may also enable the user to market their own personal information for the purposes of tailoring content on various websites and internet applications while profiting themselves from the use of their own personal information.

The tech giants mine user data in order to sell users advertising, creating a data environment where the user is completely taken advantage of. Personal private data is collected, bought, and sold without the full understanding and consent of the user. A computing device configured to perform the techniques described herein may act as a broker to enable the user to profit off of their own personal information rather than give that information to third-party services for free such that those services can profit off of the user's personal information. In this way, the computing device may guide the user through the process of managing their personal information stored on third-party servers in a computationally efficient manner, in a manner that follows the laws and guidelines applicable to both the user and the third party, and in a manner that solves a problem inherent in the technology of the internet, websites, and personal computer use where the users feel that they have no control or privacy in the manner in which they use their personal computers.

In one example, the disclosure is directed to a method that includes requesting, by one or more processors of a computing device, personal information for a user stored on a third-party server. The method also includes receiving, by the one or more processors, the personal information for the user from the third-party server. The method further includes marketing, by the one or more processors, the personal information for the user on behalf of the user.

In another example, the disclosure is directed to a computing device comprising a memory and one or more processors. The one or more processors are configured to request personal information for a user stored on a third-party server. The one or more processors are also configured to receive the personal information for the user from the third-party server. The one or more processors are further configured to market the personal information for the user on behalf of the user.

In another example, the disclosure is directed to a non-transitory computer-readable storage medium comprising instructions that, when executed by one or more processors of a computing device, cause the one or more processors to request personal information for a user stored on a third-party server. The instructions also cause the one or more processors to receive the personal information for the user from the third-party server. The instructions further cause the one or more processors to market the personal information for the user on behalf of the user.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a conceptual diagram showing a top-front perspective view of an example computing device configured to perform the techniques described herein.

FIG. 2 is a block diagram illustrating a more detailed example of a computing device configured to perform the techniques described herein.

FIG. 3 is a conceptual diagram showing a top-front perspective view of an example computing device configured to perform the techniques described herein.

FIG. 4 is a conceptual diagram showing a top-rear perspective view of an example computing device configured to perform the techniques described herein.

FIG. 5 is a conceptual diagram showing a bottom-front perspective view of an example computing device configured to perform the techniques described herein.

FIG. 6 is a conceptual diagram showing a top-front perspective view of a top portion of an example computing device configured to perform the techniques described herein.

FIG. 7 is a conceptual diagram showing a top-front perspective view of a bottom portion of an example computing device configured to perform the techniques described herein.

FIG. 8 is a conceptual diagram showing a perspective view of a pivot cylinder used in an example computing device configured to perform the techniques described herein.

FIG. 9 is a conceptual diagram showing a top-front perspective view of a single-board computer (SBC) enclosure in an example computing device configured to perform the techniques described herein.

FIG. 10 is a conceptual diagram showing a top-front perspective view of a pivot drawer in an example computing device configured to perform the techniques described herein.

FIG. 11 is a conceptual diagram showing a top-front perspective view of an on/off button in an example computing device configured to perform the techniques described herein.

FIG. 12 is a conceptual diagram showing a top-front perspective view of a plurality of screw plugs in an example computing device configured to perform the techniques described herein.

FIG. 13 is a conceptual diagram showing a top-front perspective view of an SBC computer in an example computing device configured to perform the techniques described herein.

FIG. 14 is a conceptual diagram showing a top-front perspective view of an example computing device without a top portion, the computing device configured to perform the techniques described herein.

FIG. 15 is a conceptual diagram showing a top-front perspective view of an example computing device without a top portion, a drawer, or an SBC enclosure, the computing device configured to perform the techniques described herein.

FIG. 16 is a conceptual diagram showing a top-front perspective view of a plurality of hex screws for an example computing device configured to perform the techniques described herein.

FIG. 17 is a conceptual diagram showing a top-front perspective view of a plurality of SBC standoffs in an example computing device configured to perform the techniques described herein.

FIG. 18 is a flow diagram illustrating an example technique of this disclosure.

FIG. 19 is a conceptual diagram illustrating an example technique of this disclosure.

FIG. 20 is a conceptual diagram illustrating an example technique of this disclosure.

FIG. 21 is a flow diagram illustrating an example technique of this disclosure.

FIG. 22 is a flow diagram illustrating an example technique of this disclosure.

FIG. 23 is a flow diagram illustrating an example technique of this disclosure.

### DETAILED DESCRIPTION

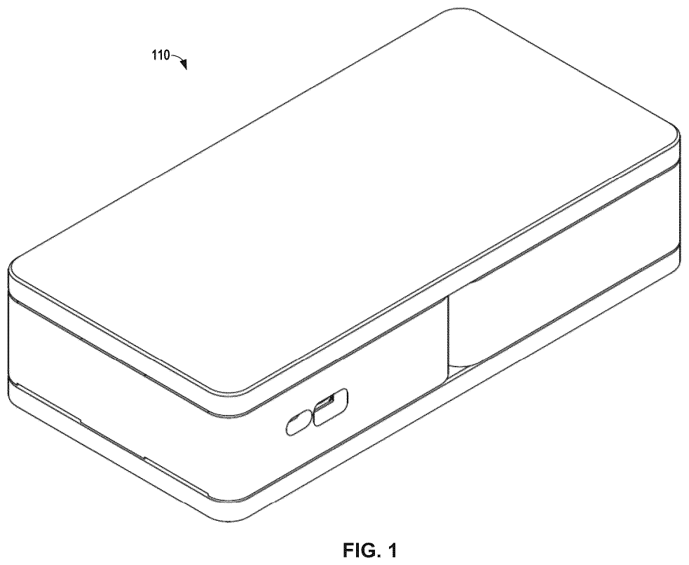

FIG. 1 is a conceptual diagram showing a top-front perspective view of an example computing device 110 configured to perform the techniques described herein. Computing device 110 may be any computing device, either standalone or connected with one or more other computing devices, that is configured to either store data objects locally or communicate with a cloud storage device to store the data objects in a central server. Computing device 110 may include a local or external power source, one or more ports for communicating with external input/output devices or control devices, and/or a communication unit to communicate with one or more external devices for the purpose of transmitting or receiving data objects. While FIG. 1 shows a specifically shaped example of computing device 110, computing device 110 is merely an example and is not meant to be limiting as to the physical look of computing device 110. Any computing device that may be configured to perform the techniques of this disclosure may be an example of computing device 110.

Computing device 110 may solve multiple problems. Online storage services may be unequitable. The tech giants mine user data in order to sell users advertising, creating a data environment where the user is completely taken advantage of. Personal private data is collected, bought, and sold without the full understanding and consent of the user. Network attached storage devices may not be optimized for personal data, are not real computers, look cheap, and often work poorly. The hardware devices are not integrated properly with the software interface which customers must use. The way humans treat their personal data can and should be modified to reflect the importance of precious personal data of a lifetime. There is currently no product specifically designed to allow people to capture, curate and control their personal data in a private yet powerful way. Digital instances of personal data are spread out all over (computers, phones, online services, network attached devices) and are poorly designed for legacy transfer. There is currently no product which allows people to capture and immediately store personal data on a private, local device optimized for storing that personal data.

In some instances, computing device 110 may act as a broker to enable the user to profit off of their own personal information rather than give that information to third-party services for free such that those services can profit off of the user's personal information. Computing device 110 may either automatically request or walk the user through the process of requesting to obtain their own personal data collected and stored by these third-party services, automatically request or walk the user through the process of requesting that the third-party services delete their personal data stored by these third-party services, and then act as a broker to these same third-party services to sell access to that personal information such that the user can profit off of their valuable data.

To start this process, computing device 110 may confirm an identity of the user. This identity check may include processes such as driver's license confirmation, photo identification confirmation, biometric authentication, address authentication (GPS), email authentication (e.g., multifactor authentication or two-step authentication, such as click an emailed link and enter a code), or other multi-factor authentication, such as with cell phones. Computing device 110 may also determine that two or more items are all in proximity to one another (e.g., a smartphone, computing device 110, and a wearable device such as a smart bracelet or smart glasses). This may ensure that the user may their identity to the third-party services, such as via a mobile phone application. For example, if two or more of the devices are verified in the same physical location, and the user also just passed two-factor authentication in the app, positive identity verification is greatly assisted.

Data is generally received as an email attachment, although other examples may include placing the text in the body of the email or as a hard copy on paper. In other instances, computing device 110 may receive the personal information via direct transmission, peer-to-peer (P2P) transmission, or some other form of a text file. In some instances, computing device 110 may monitor the user's email (so long as the user has explicitly opted in to such a service) so that computing device 110 can automatically detect when an email is delivered that includes the user's personal information, scanning body of email and/or attachments to that email to extract the personal information into a form usable by computing device 110.

Computing device 110 may perform a delete request in the same way, using a different web form but either providing instructions to the user to fill it out or completing the form automatically for the user. Computing device 110, or software on a clearinghouse server, may also automatically check whether the company actually deleted the information after some period of time (e.g., the CCPA requires that services delete data within 90 days of the request, so computing device 110 may check the service after 90 days, or periodically until that 90 day mark is reached or until computing device 110 determines that the personal data has been deleted).

The techniques of this disclosure allow the consumer to prepare and transmit their authenticated request to third-party servers, requesting receipt of their personal information. When the third-party servers respond, the software is ready to receive the personal information if the information is transmitted electronically. If the personal information is received in paper form, the application assists in capturing the printed information and digitizing it.

Secure storage of personal information is provided on computing device 110 and/or an optional secure cloud storage account (in the examples where computing device 110 is a server device). Once the personal information is securely stored, computing device 110 acts as a broker which selectively sells or rents out for a fixed period of time the consumer's personal information to advertisers and others who desire access to the information. An artificial intelligence agent created from the user's personal data knows the user's preferences, and acts as a gatekeeper and toll collector. More tools in software executed by computing device 110 allow the user to specify what products and services the user is interested in now and possibly in the future.

Another set of tools allows the consumer to opt into having his or her behavior observed and analyzed by an AI to divine interests and proclivities in a private way, with an information barrier between this closed system and the outside Internet. Still more tools allow the customer to opt out of any advertising channels as they desire. The AI Agent mentioned above acts as a gatekeeper for advertising information.

This smart agent may get out information in real time and monitor information on third party websites in real time. The agent may also verify information on third party websites is true and accurate and authorize the use of that data by third parties. This process begins with an inquiry from a marketer to a clearinghouse server (e.g., a middleman server between the marketer and computing device 110). The advertiser/marketer requests access to consumer information for the purpose of marketing/advertising to various consumers. The clearinghouse server presents information with personally identifiable information removed from data objects to allow the marketer to identify suitable candidates for campaign. Upon identification of suitable candidates, the clearinghouse allows access to personally identifiable information for the suitable candidates only.

Payments are received by the clearinghouse server from marketers only for the people where personally identifiable information is actually sent to the marketers. The clearinghouse server operator may keep a portion of the payment, with the remainder (or the entirety) of the payment being sent to the end user either through a designated bank account or online wallet.

Computing device 110 may also perform an ongoing checkup of personal information on various sites, almost like a credit report. Computing device 110 may monitor data footprint across the internet. Computing device 110 (or some other server device) may generate a data report of which sites have a user's personally identifiable data and initiate process to receive data, delete data, and use data to update your own artificial intelligence/virtual being. Computing device 110 may provide a layered security for protection of user information. For the purposes of this disclosure, any action assigned to computing device 110 may also be migrated to a cloud environment to be performed by a server with cloud data storage.

In some instances, computing device 110 may also define a new way of taking care of the personal data of a lifetime using artificial intelligence (AI). Computing device 110 may utilize a machine learning (AI) algorithm in a closed memory system to allow users to take control of their own personal data, including VPDV+AI files (Video/Photo/Documents/Voice plus Artificial Intelligence). Throughout this disclosure, “personal data” may be used to describe such VPDV+AI files, or data objects in general. Computing device 110 may be an attractive and valuable physical box for digital personal data. Computing device 110 being a physical possession adds levels of security. Computing device 110 may be elegant and is clearly something to keep, as a physical device may convey the high value commensurate with precious personal data. Computing device 110 may put the who, what, when, where, and why, plus context, in the user's hands to show what was special around important personal data. Computing device 110 may look at the whole person with its services and AI, empowering capture of the essence of the individual.

The AI utilized by computing device 110 may make it easy for a user with no computer skills to upload, curate, collaborate, share, and review personal data. The algorithm must learn to do as many tasks as possible automatically, including tagging people, events, dates, places. The results from AI and human tagging go into the “Review” section. Review presents a steady stream of favorites for every user without having to lift a finger.

The AI may also become an expert at telling stories, choosing which story to tell at the right moment. By computing device 110 telling stories, computing device 110 may make the stories emotionally impactful, and may reward the AI for emotional stories. Computing device 110 may also provide memory therapy in this way, which may help people to feel better by reviewing favorite personal data.

To better classify personal data, computing device 110 may ask AI personal data questions to find favorite personal data, bringing them forward. As such, computing device 110 may capture and describe the whole person. These files may even be included in giftbox files, or curated personal data ready to be gifted, or a physical book of personal data, in addition to general curated videos, immersive personal data files, files for sharing in personal data rooms (a dedicated virtual space for sharing personal data) or personal website (creating a type of social media), a Wikipedia page, or private pages to share with others privately.

Computing device 110 may use the AI algorithm to learn about the given person and output some results, such as “X” files scanned or some stories about the user. The AI algorithm may initially focus on “Personal Data Curation”. The user may be prompted to comment, explain, and elaborate on personal data, either by voice, in writing, or both. The AI algorithm may sense what the user is doing and present appropriate options. For example, if the user takes a photo and sees “Curate? Y/N,” the yes option may add time and location stamps, and automatically upload the personal data to computing device 110.

The AI algorithm may access a mobile device's accelerometer and learn what the person is doing. Computing device 110 may then anticipate what personal data the user might be uploading. This may be tightly integrated to an external device, such as a wearable bracelet or glasses, when it is being used.

In some instances, the highest level task performed by computing device 110 may be scanning. Computing device 110 may scan all information available about the user. Computing device 110 may scan social media accounts, storage, media files, etc., and record all important details.

Throughout the disclosure, examples are described where a computing device and/or a computing system may analyze information (e.g., locations, speeds, the content of the user interface, social media accounts, media files, incoming messages, etc.) associated with a computing device only if the computing device receives permission from the user to analyze the information. For example, in situations discussed below in which the computing device may collect or may make use of information associated with the user, the user may be provided with an opportunity to provide input to control whether programs or features of the computing device can collect and make use of user information (e.g., information about a user's current location, current speed, social media accounts, media files, etc.), or to dictate whether and/or how to the computing device may receive content that may be relevant to the user. In addition, certain data may be treated in one or more ways before it is stored or used by the computing device and/or computing system, so that personally-identifiable information is removed. For example, a user's identity may be treated so that no personally identifiable information can be determined about the user, or a user's geographic location may be generalized where location information is obtained (such as to a city, ZIP code, or state level), so that a particular location of a user cannot be determined. Furthermore, computing device 110 may not perform any of the personal information gathering and deleting processes unless computing device 110 receives explicit user consent to do so. Thus, the user may have control over how information is collected about the user and used by the computing device.

Computing device 110 may also identify connections. In other words, the AI algorithm may learn about connections between users and output those results in some format to be determined.

Computing device 110 may also ask questions, or identify what parts of the user's story is most incomplete, prompting the user to fill in the missing information. This includes questionnaires.

Computing device 110 may also provide output. Computing device 110 may generate a result, or a story, in several forms (e.g., a book, website, interactive CyberGuy/Gal/computerized avatar, etc.) about the person.

Computing device 110 may clean the data objects. The AI algorithm may learn to clean out the pauses, umms, and other unneeded blather from voice recording.

As the AI algorithm learns, computing device 110 may may provide feedback to the user about connections with other people, especially family and friends. Computing device 110 may also inform the user when a substantially updated version of their computerized avatar has been produced, showing what is missing or must be improved in their profile.

Computing device 110 may determine, after receiving user consent to do so, time-wise what a user did, when, and where, location-wise where a user was and when, work-wise what a user did, the results, the impact, and when, and what the user likes. Computing device 110 may put all this together in a searchable, publishable, save-able, share-able archive in printed, saved and published form. Computing device 110 may inform the user as to their progress (%) to completion and prompt the user to take action and answer questions. Computing device 110 may create questionnaires for AI Personal Data Questions which the user can complete easily, at their own pace, in written or verbal form.

Computing device 110 may look for the personal data, figuring out what is missing and prompt the user to fill it all out. Computing device 110 may include interrogative software powered by that AI algorithm, a database of questions, and an interactive user interface featuring the computer-generated face of an artificial intelligence agent which studies the user's profile and personal data folders to learn about the user. Computing device 110 may then ask the user questions about their personal data either in writing or by voice interaction. Computing device 110 may adapt and adjust questions on-the-fly based on previous answers to get a more complete picture of the user's personal data.

Computing device 110 may search all available information and produce Personal Data Questions (without user interaction). When the user is active in the application, computing device 110 may output a prompt. Personal data questions can be asked and answered by text or voice. The AI looks at personal data stubs and tries to determine priority (the most important ones), then puts those first for personal data questions

Computing device 110 may utilize AI-powered interactive software to prompt users to describe their personal data. Computing device 110 may adapt and query the user about personal data depending on the user's mood and indications of preferences. Computing device 110 may aim to get the user talking, providing coverage of their life history (who, what, when, where, why wherever possible), get the user remembering pleasant thoughts, and unburden the user of suppressed personal data and regrets. Computing device 110 may transcribe the questions and answers and place the files into the user's personal data files.

Personal data questions may include a tree with branching patterns. How the questions branch depends on what data is available. If the profile is empty, questions may begin with name, year of birth, city of birth, and/or city of residence. If the data object begins with a photo, then computing device 110 may scan the metadata and enter the metadata into the database.

Computing device 110 may perform photo analysis to determine what is shown on the picture. If there are people, computing device 110 may attempt to identify them. If the data object begins with text, then computing device 110 may enter the text is into the database and analyzed. If the data object begins with voice, computing device 110 may convert the voice to text, enter the text into the database, and analyze the text.

After the first data object details are determined above, then computing device 110 may determine what personal data questions to ask. As details are filled into the personal data timeline, computing device 110 may determine what are the most important missing details and attempt to answer them by interacting with the user. If the user is active, computing device 110 may recognize this and ask the user to record more personal data.

For AI personal data questions, computing device 110 may implement a chat bot powered by an AI algorithm which asks the user questions about their personal data. Questions can be asked either in writing, in the form of a chat discussion, or verbally by a text-to-voice generator which converts oral answers back into text. Computing device 110 may adapt the questions to focus in on what the user is most interested in. The questions and answers become an important part of the user's collection of personal data. Computing device 110 may use the results of AI personal data curation and AI personal data questions for memory therapy, where a series of positive personal data objects are presented to the user for the purpose of boosting their spirits.

Computing device 110 may generate an “AI agent,” or a computerized avatar, based on the personal data of the user. It is intended that this AI agent can be directed to interact with humans and other AI agents now and well into the future. The AI agent may be tasked with representing the interests of its owner now and after death, well into the future.

Computing device 110 may store the data objects in a blockchain structure for the purpose of authenticating personal data. The use of blockchain technology ensures that the data associated with the data objects/personal data is immutable and valid throughout the lifecycle. A blockchain is a series of blocks that are linked to one another using cryptography, such as a hash function. Each block of the blockchain includes a hashed version of the previous block of the blockchain, a timestamp of the update to the blockchain, the new information for the blockchain, and, potentially, additional information about the transaction adding the new information, such as a user identification or some other sort of metadata. The initial instance of a new transaction is issued from some node in the system and to another node in the system. If the issuer node is connected to each other node in the system, the issuer node may distribute the update to each other node in the system, enabling every node in the system to maintain an immutable, up-to-date version of the blockchain upon the blockchain being updated. In other instances, such as where the issuer node is not connected to other nodes in the system, a peer-to-peer network may be utilized to distribute the blocks throughout the nodes participating in the blockchain storage system. By including a hashed version of the previous block and a timestamp for each transaction in each block of the blockchain, nodes in the peer-to-peer network need not explicitly receive each block in the system, but may always ensure the node is storing the most up-to-date version of the blockchain possible through comparison of the timestamp in the most recent block stored on the node to a timestamp in the most recent block stored on another node in the peer-to-peer network.

Furthermore, each node may individually verify that any updates to the blockchain are valid using the hashed version of the previous block that must be included in any transaction to the blockchain. For instance, if a node determines that the hashed portion of a new transaction does, in fact, include the most recent block of the blockchain stored in the node, then the node may approve the transaction as a valid transaction. Conversely, if the node determines that the hashed portion of the new transaction does not include the most recent block of the blockchain stored in the node, then the node may determine the transaction is invalid. Furthermore, since each block includes a hash of the previous block, a most recent block of the blockchain would include, in order, a history of every valid transaction in the blockchain. As such, if the node determines that various details of the history of blocks hashed into the most recent block is incorrect, the node may determine that the new transaction is invalid. Furthermore, if the node determines that the timestamp information for the new block is incompatible with the most recent block in the blockchain, such as if the timestamp in the transaction is before a timestamp of the most recent block in the blockchain stored on the node, the node will determine that the transaction is invalid.

Computing device 110 may also create personal data rooms. Personal data rooms may be a video meeting service where friends and family can gather virtually to curate personal data together, where computing device 110 may store records of such meetings as data objects/personal data.

Users of this service may also set aside rewards for future designated beneficiaries or legacy custodians of the user's AI avatar and curated, blockchained personal data. Computing device 110 may empower the user to set aside money or other rewards to custodians and future custodians of the user's AI and personal data far into the future. The user first specifies a set of wishes or desires around what he or she wants to have happen with his AI avatar and personal data. The user's instructions are like an online will, which specifies rewards for carrying out the wishes of the user. This may include updating the AI avatar and personal data files using the technology of the future. Rewards are like an endowment for the care and upkeep of a person's personal data and computerized avatars.

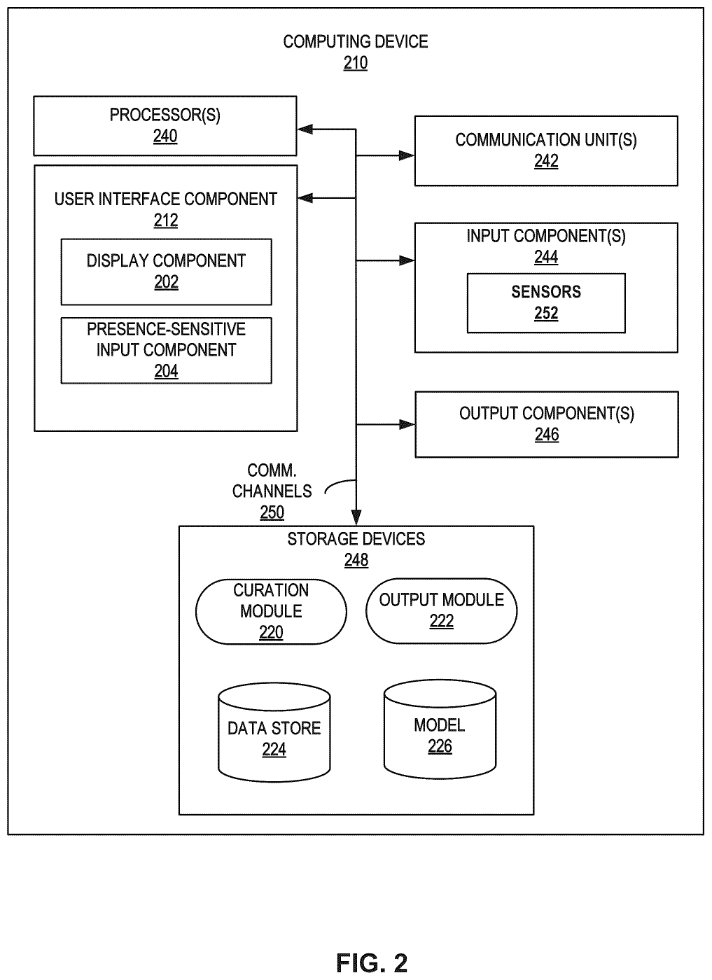

FIG. 2 is a block diagram illustrating an example computing device configured to determine a characteristic of received user input and output a corresponding set of sub-elements associated with an application on the computing device, in accordance with one or more aspects of the techniques described in this disclosure. Computing device 210 of FIG. 2 is described below as an example of computing device 110 of FIG. 1. FIG. 2 illustrates only one particular example of computing device 210, and many other examples of computing device 210 may be used in other instances and may include a subset of the components included in example computing device 210 or may include additional components not shown in FIG. 2. For instance, certain configurations of computing device 210 may merely include ports to receive external instances of user interface component 212, input components 244, and/or output components 246, or may communicate with external instances of user interface component 212, input components 244, and/or output components 246 via communication unit 242, such as over short-wavelength ultra high frequency (UHF) radio waves.

As shown in the example of FIG. 2, computing device 210 includes user interface device (UID) 212, one or more processors 240, one or more communication units 242, one or more input components 244, one or more output components 246, and one or more storage components 248. UID 212 includes display component 202 and presence-sensitive input component 204. Storage components 248 of computing device 210 include curation module 220, output module 222, data store 224, and model 226.

One or more processors 240 may implement functionality and/or execute instructions associated with computing device 210 to dynamically curate and perpetually provide access to personal data contained in any of the data objects stored in data store 224. That is, processors 240 may implement functionality and/or execute instructions associated with computing device 210 to cause curation module 220 to analyze and curate data objects received according to model 226, and may also control output module 222 to output the contents of these data objects for a user of computing device 210 or for a different user of another computing device.

Examples of processors 240 include application processors, display controllers, auxiliary processors, one or more sensor hubs, and any other hardware configure to function as a processor, a processing unit, or a processing device. Modules 218, 220, 222, and 224 may be operable by processors 240 to perform various actions, operations, or functions of computing device 210. For example, processors 240 of computing device 210 may retrieve and execute instructions stored by storage components 248 that cause processors 240 to perform the operations described with respect to modules 220 and 222 utilizing model 226. The instructions, when executed by processors 240, may cause computing device 210 to analyze and curate data objects received according to model 226, and may also control output module 222 to output the contents of these data objects for a user of computing device 210 or for a different user of another computing device.

UI module 220 may include all functionality of UI module 120 of computing device 110 of FIG. 1 and may perform similar operations as UI module 120 for managing a user interface (e.g., user interfaces 102A-102C) that computing device 210 provides at UID 212 for example, for facilitating interactions between a user of computing device 110 and application 218. For example, curation module 220 of computing device 210 may receive data objects captured by input components 244 or from an external computing device and analyze said data objects before storing the data objects in data store 224 along with the resulting classifications.

In some examples, output module 222 may execute locally (e.g., at processors 240) to provide functions associated with replaying the contents of data objects stored in data store 224. In some examples, output module 222 may act as an interface to a remote service accessible to computing device 210. For example, output module 222 may be an interface or application programming interface (API) to a remote server that provides the contents of data objects stored on other devices or servers to computing device 210 or to retrieve data objects from data store 224.

One or more storage components 248 within computing device 210 may store information for processing during operation of computing device 210 (e.g., computing device 210 may store data accessed by modules 220 and 222 during execution at computing device 210). In some examples, storage component 248 is a temporary memory, meaning that a primary purpose of storage component 248 is not long-term storage. Storage components 248 on computing device 210 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 248, in some examples, also include one or more computer-readable storage media. Storage components 248 in some examples include one or more non-transitory computer-readable storage mediums. Storage components 248 may be configured to store larger amounts of information than typically stored by volatile memory. Storage components 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 248 may store program instructions and/or information (e.g., data) associated with modules 220 and 222, data store 224, and model 226. Storage components 248 may include a memory configured to store data or other information associated with modules 220 and 222, data store 224, and model 226.

Communication channels 250 may interconnect each of the components 212, 240, 242, 244, 246, and 248 for inter-component communications (physically, communicatively, and/or operatively). In some examples, communication channels 250 may include a system bus, a network connection, an inter-process communication data structure, or any other method for communicating data.

One or more communication units 242 of computing device 210 may communicate with external devices via one or more wired and/or wireless networks by transmitting and/or receiving network signals on one or more networks. Examples of communication units 242 include a network interface card (e.g. such as an Ethernet card), an optical transceiver, a radio frequency transceiver, a GPS receiver, or any other type of device that can send and/or receive information. Other examples of communication units 242 may include short wave radios, cellular data radios, wireless network radios, as well as universal serial bus (USB) controllers.

One or more input components 244 of computing device 210 may receive input. Examples of input are tactile, audio, and video input. Input components 244 of computing device 210, in one example, includes a presence-sensitive input device (e.g., a touch sensitive screen, a PSD), mouse, keyboard, voice responsive system, camera, microphone or any other type of device for detecting input from a human or machine. In some examples, input components 244 may include one or more sensor components 252 one or more location sensors (GPS components, Wi-Fi components, cellular components), one or more temperature sensors, one or more movement sensors (e.g., accelerometers, gyros), one or more pressure sensors (e.g., barometer), one or more ambient light sensors, and one or more other sensors (e.g., infrared proximity sensor, hygrometer sensor, and the like). Other sensors, to name a few other non-limiting examples, may include a heart rate sensor, magnetometer, glucose sensor, olfactory sensor, compass sensor, or a step counter sensor.

One or more output components 246 of computing device 210 may generate output in a selected modality. Examples of modalities may include a tactile notification, audible notification, visual notification, machine generated voice notification, or other modalities. Output components 246 of computing device 210, in one example, includes a presence-sensitive display, a sound card, a video graphics adapter card, a speaker, a cathode ray tube (CRT) monitor, a liquid crystal display (LCD), a light emitting diode (LED) display, an organic LED (OLED) display, a virtual/augmented/extended reality (VR/AR/XR) system, a three-dimensional display, or any other type of device for generating output to a human or machine in a selected modality.

UID 212 of computing device 210 may include display component 202 and presence-sensitive input component 204. Display component 202 may be a screen, such as any of the displays or systems described with respect to output components 246, at which information (e.g., a visual indication) is displayed by UID 212 while presence-sensitive input component 204 may detect an object at and/or near display component 202.

While illustrated as an internal component of computing device 210, UID 212 may also represent an external component that shares a data path with computing device 210 for transmitting and/or receiving input and output. For instance, in one example, UID 212 represents a built-in component of computing device 210 located within and physically connected to the external packaging of computing device 210 (e.g., a screen on a mobile phone). In another example, UID 212 represents an external component of computing device 210 located outside and physically separated from the packaging or housing of computing device 210 (e.g., a monitor, a projector, etc. that shares a wired and/or wireless data path with computing device 210).

UID 212 of computing device 210 may detect two-dimensional and/or three-dimensional gestures as input from a user of computing device 210. For instance, a sensor of UID 212 may detect a user's movement (e.g., moving a hand, an arm, a pen, a stylus, a tactile object, etc.) within a threshold distance of the sensor of UID 212. UID 212 may determine a two or three-dimensional vector representation of the movement and correlate the vector representation to a gesture input (e.g., a hand-wave, a pinch, a clap, a pen stroke, etc.) that has multiple dimensions. In other words, UID 212 can detect a multi-dimension gesture without requiring the user to gesture at or near a screen or surface at which UID 212 outputs information for display. Instead, UID 212 can detect a multi-dimensional gesture performed at or near a sensor which may or may not be located near the screen or surface at which UID 212 outputs information for display.

In accordance with one or more techniques of this disclosure, curation module 220 may receive a data object. The data object may be one or more of a video object, a picture object, a text object, and an audio object. In receiving the data object, curation module 220 may, with user consent, retrieve the data object from a database associated with a social media platform, receive the data object sent from a media capture device, receive the data object from a secondary computing device via a wired transmission or a wireless transmission, or receive a transmission including the data object from a secondary storage device. For instance, in receiving the data object, curation module 220 may determine, based on one or more privacy settings, that a user has granted permission for the data object to be received by curation module 220. In response to determining that the user has granted permission for the data object to be received curation module 220, curation module 220 may receive the data object. In still other instances, in receiving the data object, curation module 220 may record a video conference with a plurality of users to create a video recording. Curation module 220 may save the video recording as the data object. In such instances, when curation module 220 classifies the video recording, the one or more classifications for the data object may include each of the plurality of users in the video conference.

Curation module 220 may analyze, using model 226, the data object to determine one or more classifications for the data object. Model 226 may be a machine learning model, or an AI model. In such instances, in analyzing the data object, curation module 220 may analyze, using model 226, one or more of content of the data object and metadata for the data object to determine the one or more classifications for the data object.

In some instances, curation module 220 may utilize model 226 by receiving the machine learning model from a server device that trains the machine learning model using data objects received from each of a plurality of computing devices. In other instances, curation module 220 may train model 226 itself, such as by receiving training data from a server device and updating model 226 based on the training data. In still other instances, curation module 220 may receive personal data collected by a third-party internet service and update the machine learning model based on the personal data. In still other instances, curation module 220 may train model 226 by outputting the one or more classifications for the data object, receiving an indication of first user input altering one or more of the one or more classifications to create one or more updated classifications, receiving an indication of second user input confirming one or more of the one or more classifications to create one or more confirmed classifications, and updating model 226 based on the one or more updated classifications and the one or more confirmed classifications.

Curation module 220 may perform an initial analysis on the data object to determine one or more uncertainties regarding the content of the data object. Curation module 220 may then create one or more inquiries (e.g., the above mentioned personal data questions) for each of the one or more uncertainties. Curation module 220 may receive an answer for one or more of the one or more inquiries. Curation module 220 may then determine the one or more classifications for the data object based on the answer for the one or more of the one or more inquiries.

Curation module 220 may perform the initial analysis in a variety of ways, depending on the type of data object being analyzed. For instance, curation module 220 may determine content for the data object by performing an audio analysis to determine one or more audible words or sounds present in the data object, a graphical analysis to determine one or more living or non-living objects present in the data object, an optical character recognition to determine one or more visible words in the data object, or a metadata analysis to determine one or more of a location, time, and date of capture for the data object.

Curation module 220 may determine the one or more classifications for the data object as anything that could potentially be descriptive of the data object or the contents of the data object. For instance, the one or more classifications could include one or more of one or more persons contained in the data object, one or more animals contained in the data object, one or more objects contained in the data object, one or more events associated with the data object, one or more locations associated with the data object, one or more dates associated with the data object, one or more times associated with the data object, one or more relationships with one or more subjects contained in the data object, and one or more times of year at which the data object was created. Each of the one or more classifications may be either a previously created classification associated with a second data object stored in data store 224 or a newly created classification not associated with any other data object in data store 224.

In addition to the content analysis, curation module 220 may a more subjective analysis on the data objects. For instance, curation module 220 may output one or more requests for subjective feelings of the user regarding the data object, such as the personal data questions. Curation module 220 may receive an indication of user input indicative of the subjective feelings of the user regarding the data object. Curation module 220 may store the subjective feelings of the user regarding the data object in data store 224 with the data object and the one or more classifications. Curation module 220 may also update model 226 based on the subjective feelings of the user regarding the data object.

Curation module 220 may also output a request for a narrative descriptive of the data object, where the narrative is a written narrative or an audible narrative. Curation module 220 may receive an indication of user input that includes the narrative for the data object and store the narrative for the data object in data store 224. When the user wishes to review the personal data associated with this data object, output module 222 may output the data object and may also output, substantially simultaneously with the data object (e.g., as a voiceover to a picture or video in the data object), the narrative for the data object.

Any of the above inquiries may be one or more of one or more textual inquiries, one or more audible inquiries, and one or more chatbot inquiries. Output module 222 may output the one or more inquiries, such as via one of output components 246. In creating the one or more inquiries, curation module 220 may create the one or more inquiries for each of the one or more uncertainties using model 226. Curation module 220 may then analyze, using model 226, one or more of the narrative and the answer to each respective inquiry of the one or more inquiries to further classify the respective data object with a feeling for the respective data object. Curation module 220 may group the data object with other data objects that are classified with similar feelings. This may allow curation module 220 to provide memory therapy by presenting one or more data objects that have a same feeling classification.

Curation module 220 may store the data object and the one or more classifications for the data object in data store 224. Curation module 220 may also edit the data object to remove one or more portions of the data object prior to create an edited data object and store the edited data object in data store 224. For instance, in editing the data object, curation module 220 may determine each the one or more portions of the data object to be removed as a portion that includes undesirable content, such as by including no audio or verbal miscues (e.g., “ummm”s).

Data store 224 may include a plurality of data objects, and curation module 220 may store the plurality of data objects in data store 224, where each of the plurality of data objects is stored with one or more classifications for the respective data object. In this manner, data store 224 may naturally group the data objects. Output module 222 may receive an indication of user input indicative of one or more requested classifications. In response to receiving the indication of user input, output module 222 may retrieve, from data store 224, one or more of the plurality of data objects with respective classifications that are equal to the one or more requested classifications. Output module 222 may then output one or more of those data objects in the retrieved group.

Output module 222 may determine favorite personal data. Output module 222 may do so by receiving a request to access the data object, outputting the data object, and increasing an access counter for the data object. Output module 222 may later output an interface for accessing a subset of the plurality of data objects, the subset including a number of data objects with a greatest respective access counter.

Output module 222 may define one or more privacy settings for the data object. The one or more privacy settings define access for one or more other users of a social platform over which the data object is shared with the one or more other users. In this social platform, output module 222 may generate a graphical environment including one or more of the plurality of data objects in data store 224. Output module 222 may send the graphical environment to a server device of the social platform with the one or more privacy settings for the graphical environment.

Output module 222 may generate a second graphical environment that includes a second set of one or more of the plurality of data objects. Output module may send the second graphical environment to the server device of the social platform with a second set of one or more privacy settings for the graphical environment. In this way, output module 222 may allow different sets of users access to different personal data of the user based on explicit user instructions and privacy settings.

Output module 222 may receive an indication of user input indicative of a requested update to the graphical environment. Output module 222 may generate, based on the requested update to the graphical environment, an updated graphical environment, and send the updated graphical environment to the server device of the social platform. In this way, output module 222 may allow the user to update their graphical environments within the social platform as they so desire.

Users may also use computing device 210 to access the social platform and the personal data of other users. Output module 222 may request a friendly graphical environment from the server device, with the friendly graphical environment being one or more data objects associated with a second user different than the user. In response to the server device determining that the user is allowed access to the friendly graphical environment, output module 222 may receive the friendly graphical environment and output the friendly graphical environment. The server device may also deny the user access to this graphical environment if the owner of the graphical environment has not granted the user access.

The graphical environment includes a particular arrangement of the one or more of the plurality of data objects. The graphical environment may be one or more of a flat graphical user interface containing the particular arrangement, a virtual reality user interface containing the particular arrangement, an augmented reality user interface containing the particular arrangement, an audio user interface containing the particular arrangement, and an extended reality user interface containing the particular arrangement.

Curation module 220 may also generate, based on the model, an artificial intelligence profile that includes one or more of vocal characteristics of the user, relationships for the user, personal information for the user, likes for the user, dislikes for the user, visual characteristics for the user, experiences of the user, and any other defining characteristic for the user. Output module 222 may then generate a computerized avatar that acts in accordance with the artificial intelligence profile. Output module 222 may include the computerized avatar in the graphical environment. This computerized avatar may be configured to interact with one or more other users of the social media platform in the graphical environment of the user.

Curation module 220 may also define a longevity setting comprising a permission or denial of permission for the computer device to allow access to one or more aspects of the storage component after the user passes away. Output module 222 or a server device may use these longevity settings to control access to the user's personal data after the user passes away.

Curation module 220 may remove personally identifiable information from one or more objects in data store 224 to generate a set of anonymous information. Curation module 220 may send the set of anonymous information to the server device to be used for training a universal machine learning model. By removing the personally identifiable information, computing device 210 may contribute to a powerful, universal AI model without compromising the user's personal data.

In some instances, computing device 210 is a standalone computing device that includes data store 224 locally. In other instances, data store 224 may be a cloud storage component that computing device 210 accesses via a network. In storing the data object, curation module 220 may create a reference to the data object in a blockchain.

Curation module 220 may also receive one or more user death directives. Curation module 220 may receive an indication of user input that completes one of the one or more user death directives. In response to receiving this indication, curation module 220 may issue a user-defined reward to the user that completed the one of the one or more user death directives.

In accordance with the techniques of this disclosure, curation module 220 may request personal information for a user stored on a third-party server. In some instances, in requesting the personal information for the user, output module 222 may output a set of instructions for the user to follow to send a request for the personal information for the user to the third-party server. In other instances, in requesting the personal information for the user, curation module 220 may automatically request that the third-party server send the personal information for the user stored on the third-party server to using local user information stored on the computing device to create the request.

In some examples, prior to requesting the personal information for the user, curation module 220 may determine an identity of an individual that initiated requesting the personal information for the user to verify that the individual is either the user or a guardian for the user. This process could include performing an identity check process that includes one or more of a driver's license confirmation, a photo identification card confirmation, a username and password check, biometric authentication, address authentication using a global positioning system, multi-factor authentication using one or more of an email messaging service, a text messaging service, a short messaging service, or an authentication application, a security question check, communication with a physical device worn by or carried by the user, and a personal identification number (PIN) check.

Curation module 220 may receive the personal information for the user from the third-party server. Curation module 220 may receive the personal information for the user from the third-party server in any number, or combination, of ways. For instance, curation module 220 may receive the personal information for the user directly from the third-party server via direct transmission, receive the personal information for the user via a peer-to-peer transmission, monitor an email account associated with the user for an email message that includes the personal information in a body portion of the email message or as an attachment in the email message and extracting the personal information from the email message, and/or receive the personal information for the user via an upload from a physical device, operably connected to the computing device, that includes the personal information.

In some examples, curation module 220 may also send a request to the third-party server for the third-party server to delete the personal information for the user stored on the third-party server. After sending this request, curation module 220 may monitor the personal information for the user stored on the third-party server to confirm that the third-party server deleted the personal information for the user, either after a set time frame (e.g., 90 days, 120 days, or some other amount of time) or periodically within that time frame until the personal information is deleted. In sending the request to the third-party server for the third-party server to delete the personal information for the user stored on the third-party server, curation module 220 may perform some combination of outputting a set of instructions for the user to follow to send the request to the third-party server and/or automatically requesting that the third-party server delete the personal information for the user stored on the third-party server using local user information stored on the computing device to create the request.

In some examples, curation module 220 may also train an artificial intelligence model, such as model 226, using the personal information for the user. As described throughout this disclosure, curation module 220 may use model 226 to curate personal data stored in data objects, as well as use model 226 to personalize a computerized avatar/virtual being for the user.

Curation module 220, or a clearinghouse server in addition to or in place of curation module 220, may also market the personal information for the user on behalf of the user. For instance, curation module 220 may receive an indication of user input providing one or more user marketing preferences for the user. The user marketing preferences may include one or more of a list of specific marketers that the user wishes to market their personal data to, a list of specific marketers that the user wishes to hide their personal data from, a list of genres of marketers that the user wishes to market their personal data to, a list of genres of marketers that the user wishes to hide their personal data from, a limit for a number of marketers that the user wishes to sell their personal data to over a given period of time, and a minimum price threshold that the user requires from marketers to sell their personal data. Curation module 220 may upload the one or more user marketing preferences and the personal information for the user to a clearinghouse server, either before removing or after removing personally identifiable information from the personal information. If curation module 220 does not remove the personally identifiable information first, the clearinghouse server may remove the personally identifiable information from the personal information to create an anonymous profile for the user including the one or more user marketing preferences. The anonymous profile is one of a plurality of anonymous profiles, and each anonymous profile of the plurality of anonymous profiles is associated with a different user. If curation module 220 has already removed the personally identifiable information, the clearinghouse server may simply create the anonymous profile with the anonymous information.

The clearinghouse server may receive a request for the plurality of anonymous profiles from a marketer. The clearinghouse server may send the plurality of anonymous profiles to the marketer. The marketer may determine which anonymous profiles are suitable candidates for advertising, and the clearinghouse server may receive an indication of a subset of anonymous profiles from the plurality of anonymous profiles. Each anonymous profile of the subset of anonymous profiles is associated with a user that the marketer is requesting to provide advertisements to, where the subset of anonymous profiles includes the anonymous profile for the user. The clearinghouse server may send the personally identifiable information for each of subset of anonymous profiles, including the personally identifiable information for the anonymous profile of the user, to the marketer with a request for a payment. The clearinghouse server may receive the payment from the marketer and distribute at least a portion of the payment to a payment account of the user and to a payment account of each user associated with an anonymous profile of the subset of anonymous profiles. The payment account of the user may be a bank account or an online wallet provided by the clearinghouse server.

Curation module 220 may also monitor a group of one or more third-party services to determine what personal information for the user is stored on each of the third-party services of the group of one or more third-party services. In monitoring the personal information, curation module 220 may verify, based on locally stored user information in data store 224, that the personal information for the user stored on each of the third-party services of the group of one or more third-party services is accurate, as well as issue, to a first third party service of the group of one or more third-party services, a request to update any personal information on the first third party service that is inaccurate.

Curation module 220 may also generate a privacy report based on the determination of what personal information for the user is stored on each of the third-party services of the group of one or more third-party services. Output module 222 may output the privacy report, either in printed form or electronic form, for viewing by the user.

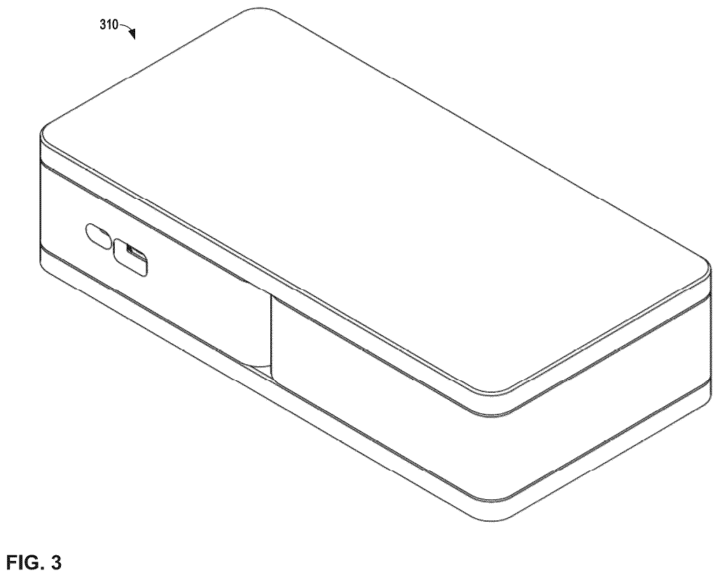

FIG. 3 is a conceptual diagram showing a top-front perspective view of an example computing device 310 configured to perform the techniques described herein. Computing device 310 may be similar to and may perform the functions of computing device 110 of FIG. 1 or computing device 210 of FIG. 2. While FIG. 3 shows a specific example of a computing device that may perform the techniques of this disclosure, computing device 310 is merely an example and is not meant to be limiting as to the physical look of computing device 310. Any computing device that may be configured to perform the techniques of this disclosure may be an example of computing device 310.

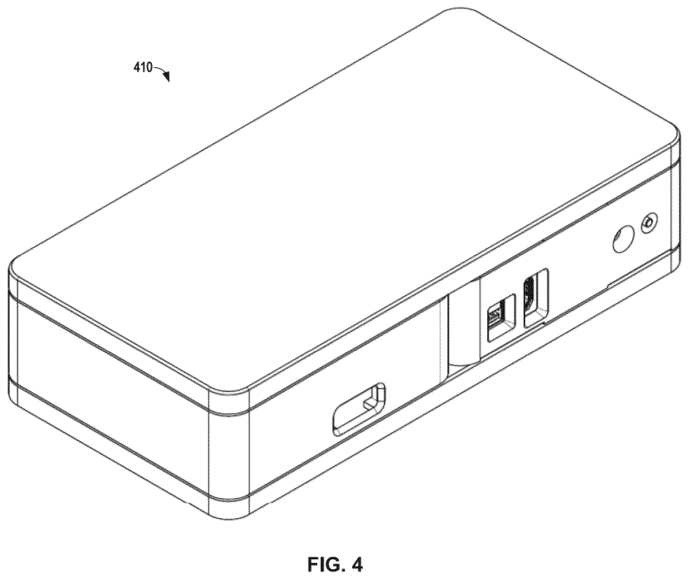

FIG. 4 is a conceptual diagram showing a top-rear perspective view of an example computing device 410 configured to perform the techniques described herein. Computing device 410 may be similar to and may perform the functions of computing device 110 of FIG. 1 or computing device 210 of FIG. 2. While FIG. 4 shows a specific example of a computing device that may perform the techniques of this disclosure, computing device 410 is merely an example and is not meant to be limiting as to the physical look of computing device 410. Any computing device that may be configured to perform the techniques of this disclosure may be an example of computing device 410.

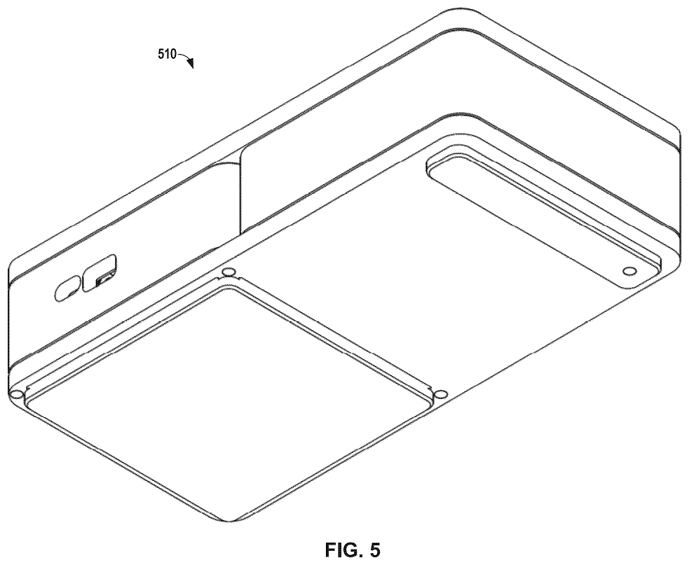

FIG. 5 is a conceptual diagram showing a bottom-front perspective view of an example computing device 510 configured to perform the techniques described herein. Computing device 510 may be similar to and may perform the functions of computing device 110 of FIG. 1 or computing device 210 of FIG. 2. While FIG. 5 shows a specific example of a computing device that may perform the techniques of this disclosure, computing device 510 is merely an example and is not meant to be limiting as to the physical look of computing device 510. Any computing device that may be configured to perform the techniques of this disclosure may be an example of computing device 510.

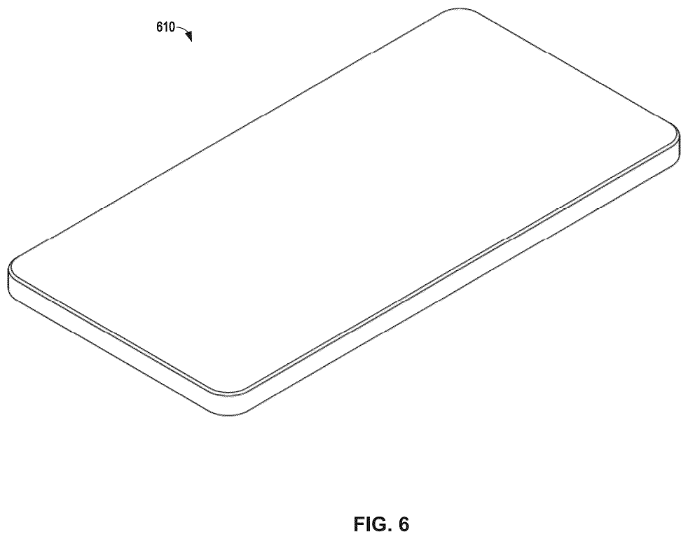

FIG. 6 is a conceptual diagram showing a top-front perspective view of a top portion 610 of an example computing device configured to perform the techniques described herein. While FIG. 6 shows a specific example of a top portion of a computing device that may perform the techniques of this disclosure, top portion 610 is merely an example and is not meant to be limiting as to the physical look of top portion 610. Any computing device that may be configured to perform the techniques of this disclosure may be used to perform the techniques of this disclosure, and a top portion of that computing device may be configured differently, or not even present at all.

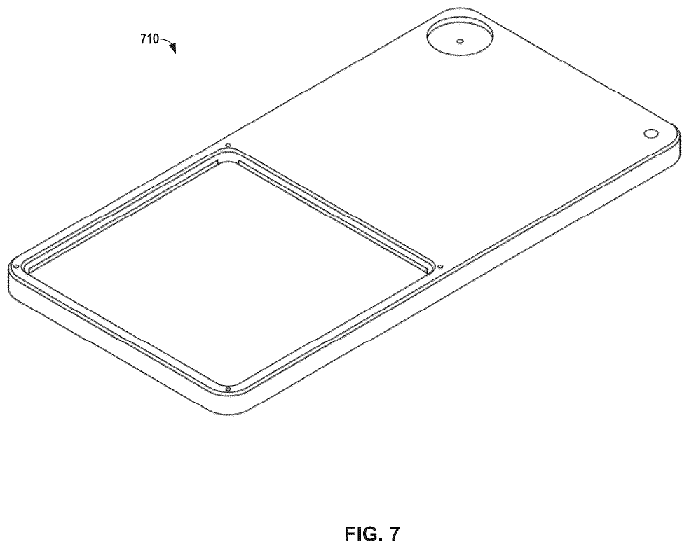

FIG. 7 is a conceptual diagram showing a top-front perspective view of a bottom portion 710 of an example computing device configured to perform the techniques described herein. While FIG. 7 shows a specific example of a bottom portion of a computing device that may perform the techniques of this disclosure, bottom portion 710 is merely an example and is not meant to be limiting as to the physical look of bottom portion 710. Any computing device that may be configured to perform the techniques of this disclosure may be used to perform the techniques of this disclosure, and a bottom portion of that computing device may be configured differently, or not even present at all.

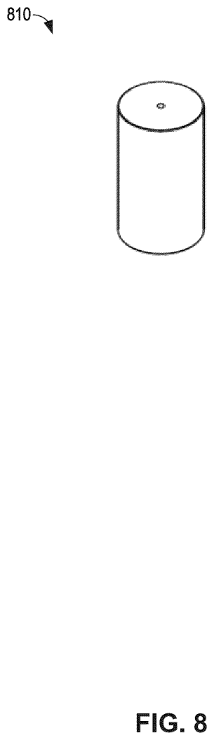

FIG. 8 is a conceptual diagram showing a perspective view of a pivot cylinder 810 used in an example computing device configured to perform the techniques described herein. While FIG. 8 shows a specific example of a pivot cylinder used in a computing device that may perform the techniques of this disclosure, pivot cylinder 810 is merely an example and is not meant to be limiting as to the physical look of pivot cylinder 810. Any computing device that may be configured to perform the techniques of this disclosure may be used to perform the techniques of this disclosure, and a pivot cylinder of that computing device may be configured differently, or not even present at all.

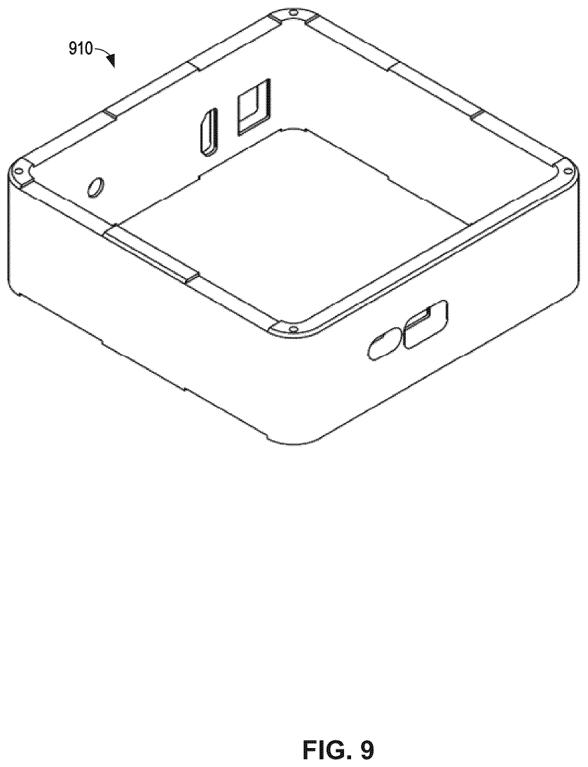

FIG. 9 is a conceptual diagram showing a top-front perspective view of a single-board computer (SBC) enclosure 910 in an example computing device configured to perform the techniques described herein. While FIG. 9 shows a specific example of an SBC enclosure of a computing device that may perform the techniques of this disclosure, SBC enclosure 910 is merely an example and is not meant to be limiting as to the physical look of SBC enclosure 910. Any computing device that may be configured to perform the techniques of this disclosure may be used to perform the techniques of this disclosure, and an SBC enclosure of that computing device may be configured differently, or not even present at all.

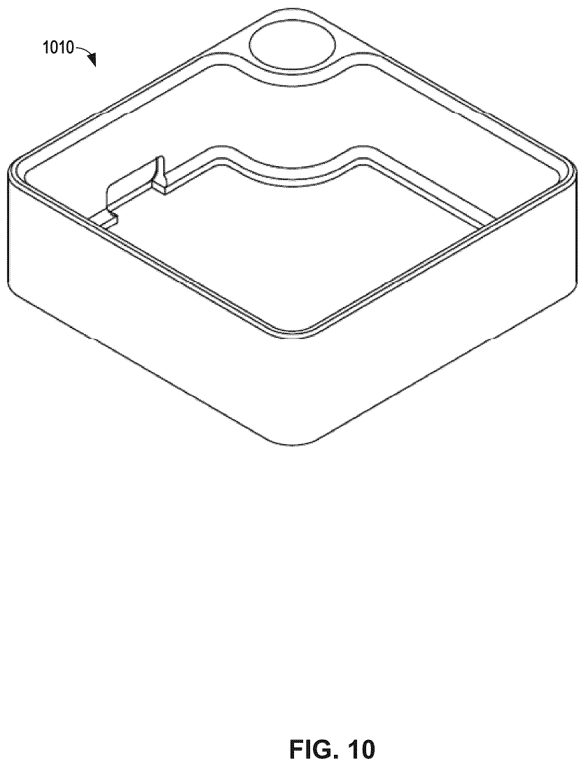

FIG. 10 is a conceptual diagram showing a top-front perspective view of a pivot drawer 1010 in an example computing device configured to perform the techniques described herein. While FIG. 10 shows a specific example of a pivot drawer of a computing device that may perform the techniques of this disclosure, pivot drawer 1010 is merely an example and is not meant to be limiting as to the physical look of pivot drawer 1010. Any computing device that may be configured to perform the techniques of this disclosure may be used to perform the techniques of this disclosure, and a pivot drawer of that computing device may be configured differently, or not even present at all.

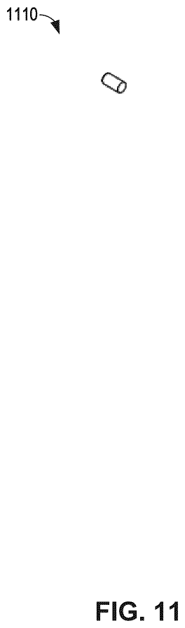

FIG. 11 is a conceptual diagram showing a top-front perspective view of an on/off button 1110 in an example computing device configured to perform the techniques described herein. While FIG. 10 shows a specific example of an on/off button of a computing device that may perform the techniques of this disclosure, on/off button 1110 is merely an example and is not meant to be limiting as to the physical look of on/off button 1110. Any computing device that may be configured to perform the techniques of this disclosure may be used to perform the techniques of this disclosure, and an on/off button of that computing device may be configured differently, or not even present at all.

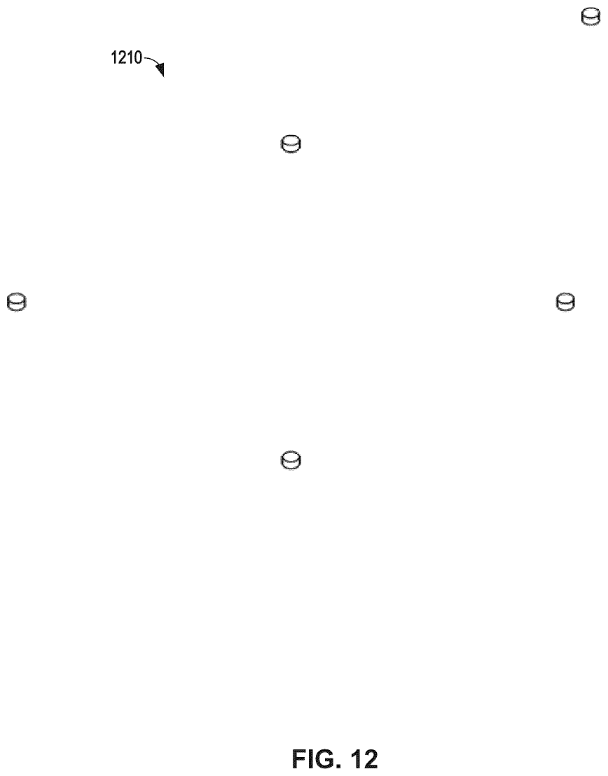

FIG. 12 is a conceptual diagram showing a top-front perspective view of a plurality of screw plugs 1210 in an example computing device configured to perform the techniques described herein. While FIG. 12 shows a specific example of screw plugs of a computing device that may perform the techniques of this disclosure, screw plugs 1210 is merely an example and is not meant to be limiting as to the physical look of screw plugs 1210. Any computing device that may be configured to perform the techniques of this disclosure may be used to perform the techniques of this disclosure, and screw plugs of that computing device may be configured differently, or not even present at all.

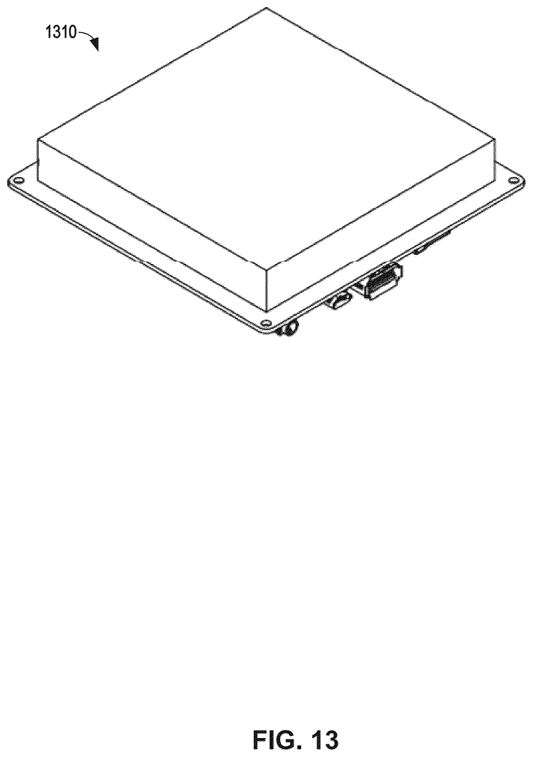

FIG. 13 is a conceptual diagram showing a top-front perspective view of an SBC computer 1310 in an example computing device configured to perform the techniques described herein. While FIG. 13 shows a specific example of an SBC computer of a computing device that may perform the techniques of this disclosure, SBC computer 1310 is merely an example and is not meant to be limiting as to the physical look of SBC computer 1310. Any computing device that may be configured to perform the techniques of this disclosure may be used to perform the techniques of this disclosure, and an SBC computer of that computing device may be configured differently, or not even present at all.

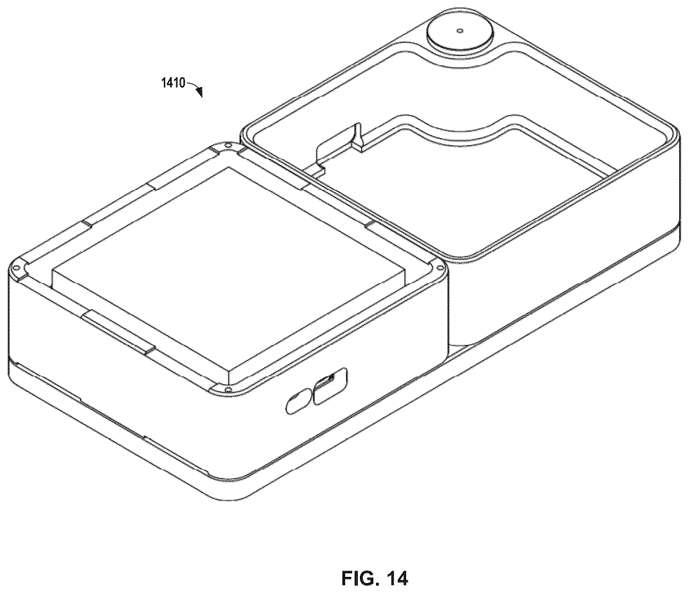

FIG. 14 is a conceptual diagram showing a top-front perspective view of an example computing device 1410 without a top portion, the computing device configured to perform the techniques described herein. Computing device 1410 may be similar to and may perform the functions of computing device 110 of FIG. 1 or computing device 210 of FIG. 2. While FIG. 14 shows a specific example of a computing device that may perform the techniques of this disclosure, computing device 1410 is merely an example and is not meant to be limiting as to the physical look of computing device 1410. Any computing device that may be configured to perform the techniques of this disclosure may be an example of computing device 1410.

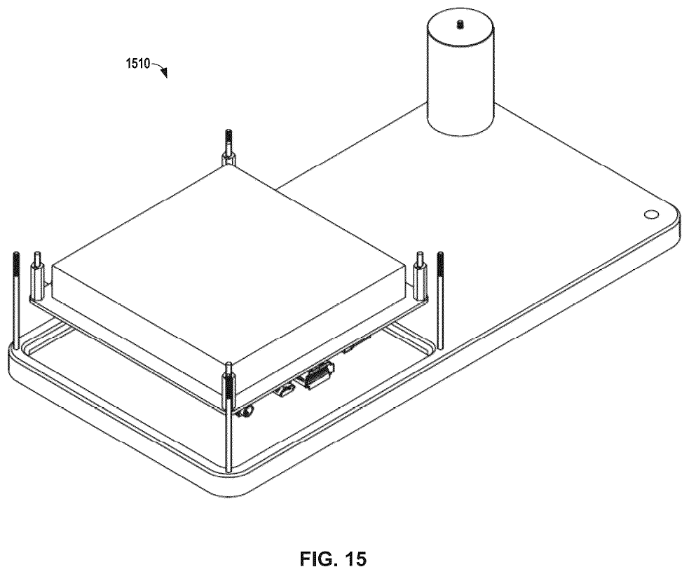

FIG. 15 is a conceptual diagram showing a top-front perspective view of an example computing device 1510 without a top portion, a drawer, or an SBC enclosure, the computing device configured to perform the techniques described herein. Computing device 1510 may be similar to and may perform the functions of computing device 110 of FIG. 1 or computing device 210 of FIG. 2. While FIG. 15 shows a specific example of a computing device that may perform the techniques of this disclosure, computing device 1510 is merely an example and is not meant to be limiting as to the physical look of computing device 1510. Any computing device that may be configured to perform the techniques of this disclosure may be an example of computing device 1510.

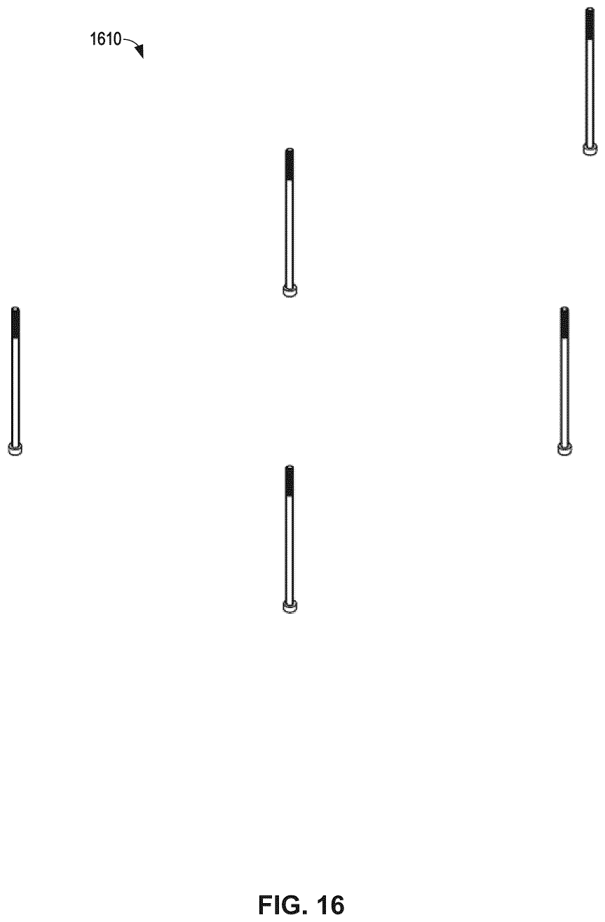

FIG. 16 is a conceptual diagram showing a top-front perspective view of a plurality of hex screws 1610 for an example computing device configured to perform the techniques described herein. While FIG. 16 shows a specific example of hex screws of a computing device that may perform the techniques of this disclosure, hex screws 1610 is merely an example and is not meant to be limiting as to the physical look of hex screws 1610. Any computing device that may be configured to perform the techniques of this disclosure may be used to perform the techniques of this disclosure, and hex screws of that computing device may be configured differently, or not even present at all.

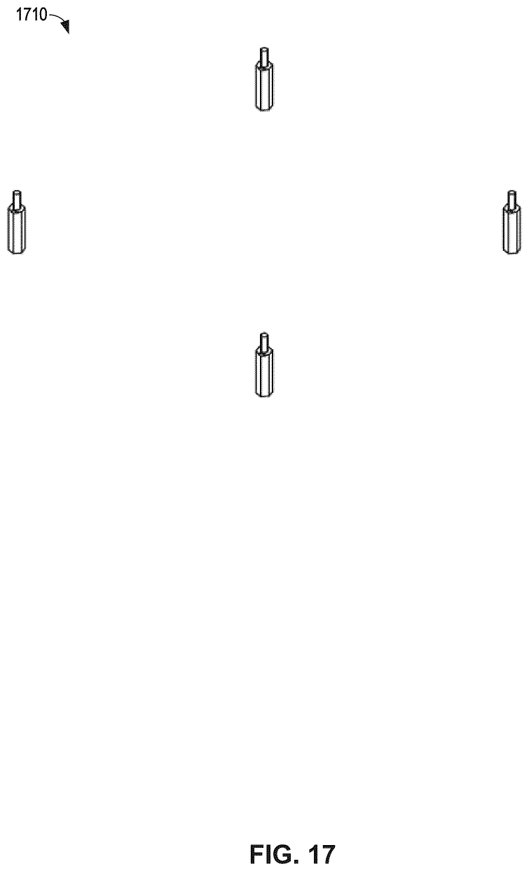

FIG. 17 is a conceptual diagram showing a top-front perspective view of a plurality of SBC standoffs 1710 in an example computing device configured to perform the techniques described herein. While FIG. 17 shows a specific example of SBC standoffs of a computing device that may perform the techniques of this disclosure, SBC standoffs 1710 is merely an example and is not meant to be limiting as to the physical look of SBC standoffs 1710. Any computing device that may be configured to perform the techniques of this disclosure may be used to perform the techniques of this disclosure, and SBC standoffs of that computing device may be configured differently, or not even present at all.

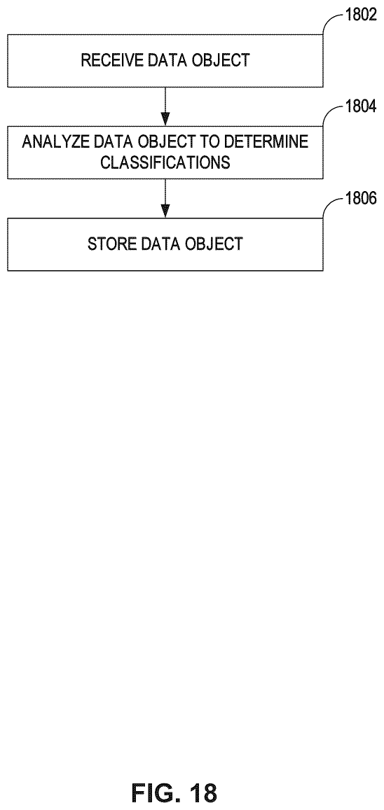

FIG. 18 is a flow diagram illustrating an example technique of this disclosure. The techniques of FIG. 18 may be performed by one or more processors of a computing device, such as computing device 110 of FIG. 1 and/or computing device 210 illustrated in FIG. 2. For purposes of illustration only, the techniques of FIG. 18 are described within the context of computing device 210 of FIG. 2, although computing devices having configurations different than that of computing device 210 may perform the techniques of FIG. 18.

In accordance with one or more techniques of this disclosure, curation module 220 receives a data object (1802). Curation module 220 analyzes, using model 226, the data object to determine one or more classifications for the data object (1804). Curation module 220 stores the data object and the one or more classifications for the data object in storage component 248 of computing device 210, such as in data store 224 (1806).

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

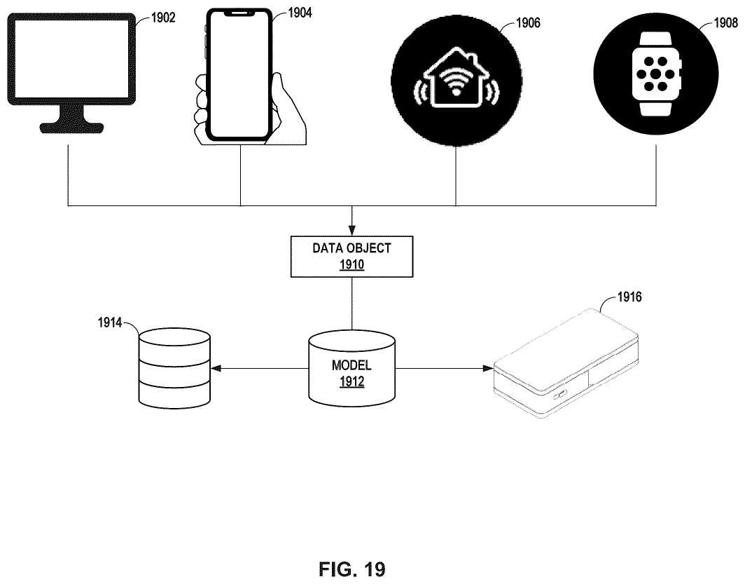

FIG. 19 is a conceptual diagram illustrating an example technique of this disclosure. In the example of FIG. 19, data object 1910 may be captured by or initially stored on one of computing device 1902, smartphone 1904, internet of things device 1906, or wearable device 1908. Computing device 1902 may be any desktop, laptop, or tablet computer that is configured to capture, store, and/or transmit data objects to a different computing device. Smartphone 1904 may be any mobile device configured to capture, store, and/or transmit data objects to a different computing device. Internet of things device 1906 may be any smart home device or other computing device that is capable of connecting to the internet and configured to capture, store, and/or transmit data objects to a different computing device. Wearable device 1908 may be any smart watch, smart eyewear, or any other computing device capable of being worn on the body of a user and is also configured to capture, store, and/or transmit data objects to a different computing device.

Any one of computing device 1902, smartphone 1904, internet of things device 1906, or wearable device 1908 may capture, or otherwise store, data object 1910. Data object 1910 may be any one or more of a picture, a video, a document, an audio file, or any other file that could be associated with personal data of some kind. Using a designated application on the respective device or a website, computing device 1902, smartphone 1904, internet of things device 1906, and/or wearable device 1908 may transmit data object 1910 to one of server device 1914 or standalone computing device 1916. Both of server device 1914 and standalone computing device 1916 are examples of computing device 210 of FIG. 2, and may perform similar functions as computing device 210 of FIG. 2. For instance, model 1912, which may be stored on either server device 1914 or standalone computing device 1916, may be used to process data object 1910 to curate data object 1910 by determining one or more classifications for data object 1910. One or more of server device 1914 and standalone computing device 1916 may store data object 1910 along with the one or more classifications.

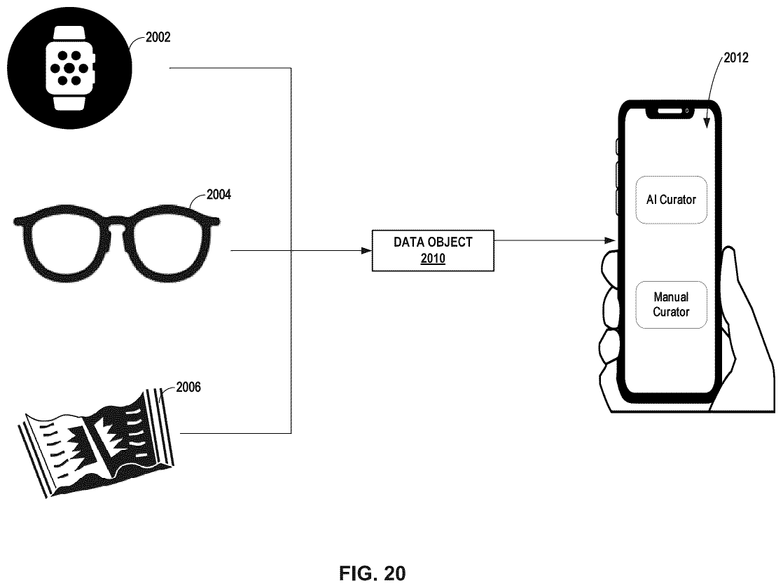

FIG. 20 is a conceptual diagram illustrating an example technique of this disclosure. In the example of FIG. 20, one of smartwatch 2002 or smart eyewear 2004 may capture, with an integrated camera, data object 2010 and transmit data object 2012 to smartphone 2012. In other instance, smartphone 2012 itself, or some other computing device with an integrated camera, may capture data object 2010. In still other instances of FIG. 20, album 2006, which may be either a digital or analog photo or video album, may transmit data object 2010 to smartphone 2012. Data object 2010 may be any one or more of a picture, a video, a document, an audio file, or any other file that could be associated with personal data of some kind. Smartphone 2012 may execute an application to be used to curate data object 2010 by determining one or more classifications for data object 2010. In some instances, the “AI Curator” option may be selected, which will cause smartphone 2012 to use a model, such as model 226 of FIG. 2, to automatically utilize artificial intelligence to curate data object 2010. In other instances, the “Manual Curator” option may be selected, which will cause smartphone 2012 to output a prompt for the user to add manual classifications or tags to associate with data object 2010. While shown as a smartphone, this application could be executed by any computing device, such as computing device 210 of FIG. 2.

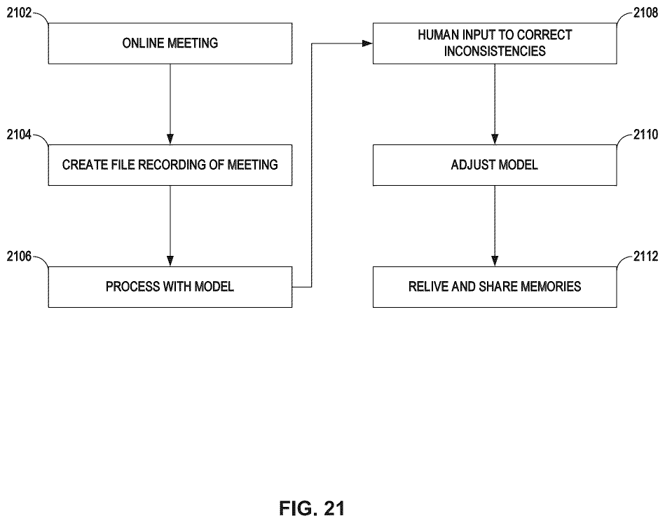

FIG. 21 is a flow diagram illustrating an example technique of this disclosure. The techniques of FIG. 21 may be performed by one or more processors of a computing device, such as computing device 110 of FIG. 1 and/or computing device 210 illustrated in FIG. 2. For purposes of illustration only, the techniques of FIG. 21 are described within the context of computing device 210 of FIG. 2, although computing devices having configurations different than that of computing device 210 may perform the techniques of FIG. 21.

In accordance with the techniques of this disclosure, a user may participate in an online meeting with one or more other users (2102). The computing device being used for the online meeting, which may be computing device 210, may record the meeting to create a file or data object that contains either a video of the meeting, an audio recording of the meeting, or a photo of the participants of the meeting (2104). Curation module 220 may process the data object with model 226 to create one or more classifications for the data object (2106). The user may additionally input any tags or classifications, or correct the one or more created classifications, to correct any inconsistencies present after the analysis by curation module 220 (2108). Curation module may adjust model 226 based on this human input (2110). Output module 2112 may then output the data object, either as a standalone playback or as part of a larger graphical environment, to review and/or share that personal data with the user and/or other users (2112).

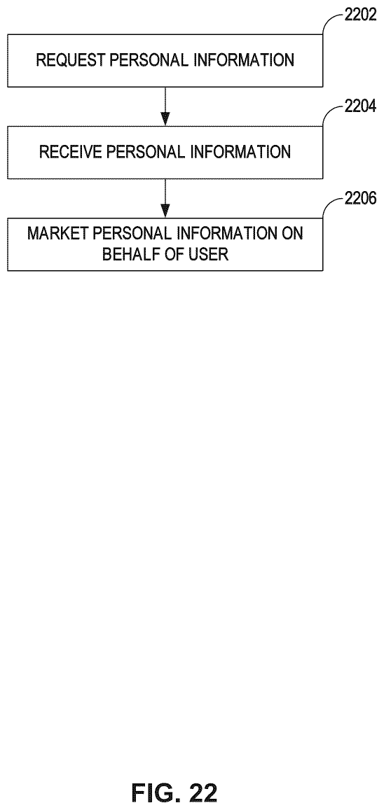

FIG. 22 is a flow diagram illustrating an example technique of this disclosure. The techniques of FIG. 22 may be performed by one or more processors of a computing device, such as computing device 110 of FIG. 1 and/or computing device 210 illustrated in FIG. 2. For purposes of illustration only, the techniques of FIG. 22 are described within the context of computing device 210 of FIG. 2, although computing devices having configurations different than that of computing device 210 may perform the techniques of FIG. 22.

In accordance with the techniques of this disclosure, curation module 220 requests personal information for a user stored on a third-party server (2202). Curation module 220 receives the personal information for the user from the third-party server (2204). Curation module 220 markets the personal information for the user on behalf of the user (2206).

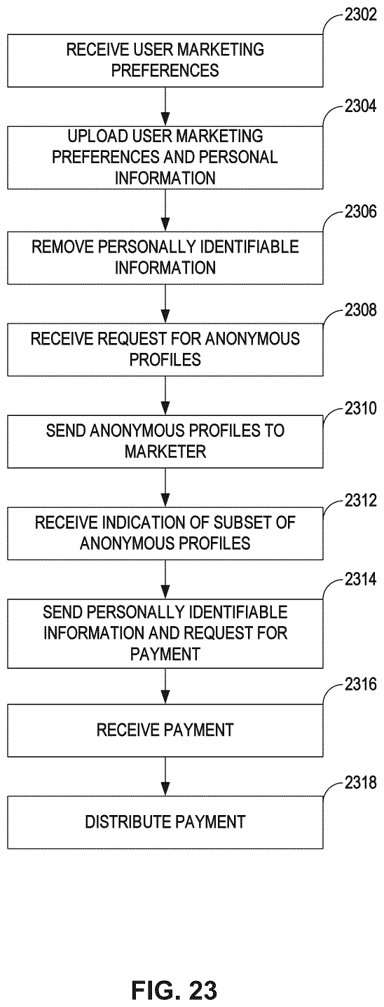

FIG. 23 is a flow diagram illustrating an example technique of this disclosure. The techniques of FIG. 23 may be performed by one or more processors of a computing device, such as computing device 110 of FIG. 1 and/or computing device 210 illustrated in FIG. 2. For purposes of illustration only, the techniques of FIG. 23 are described within the context of computing device 210 of FIG. 2, although computing devices having configurations different than that of computing device 210 may perform the techniques of FIG. 23.

In accordance with the techniques of this disclosure, curation module 220 receives an indication of user input providing one or more user marketing preferences (2302). Curation module 220 uploads the one or more user marketing preferences and the personal information for the user to a clearinghouse server (2304). Either curation module 220 or the clearinghouse server itself removes personally identifiable information from the personal information to create an anonymous profile for the user including the one or more user marketing preferences (2306). The anonymous profile is one of a plurality of anonymous profiles, and each anonymous profile of the plurality of anonymous profiles is associated with a different user.

The clearinghouse server receives a request for the plurality of anonymous profiles from a marketer (2308). The clearinghouse server sends the plurality of anonymous profiles to the marketer (2310). The clearinghouse server receives an indication of a subset of anonymous profiles from the plurality of anonymous profiles (2312). Each anonymous profile of the subset of anonymous profiles is associated with a user that the marketer is requesting to provide advertisements to, where the subset of anonymous profiles includes the anonymous profile for the user. The clearinghouse server sends the personally identifiable information for each of subset of anonymous profiles, including the personally identifiable information for the anonymous profile of the user, to the marketer with a request for a payment (2314). The clearinghouse server receives the payment from the marketer (2316) and distributes at least a portion of the payment to a payment account of the user and to a payment account of each user associated with an anonymous profile of the subset of anonymous profiles (2318).

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples of the disclosure have been described. Any combination of the described systems, operations, or functions is contemplated. These and other examples are within the scope of the following claims.

What is claimed is:

1. A method comprising:
requesting, by one or more processors of a computing device, personal information for a user stored on a third-party server;
receiving, by the one or more processors, the personal information for the user from the third-party server; and
marketing, by the one or more processors, the personal information for the user on behalf of the user.

2. The method of claim 1, further comprising:
sending, by the one or more processors, a request to the third-party server for the third-party server to delete the personal information for the user stored on the third-party server.

3. The method of claim 2, further comprising:
monitoring, by the one or more processors, the personal information for the user stored on the third-party server to confirm that the third-party server deleted the personal information for the user.

4. The method of claim 2, wherein sending the request to the third-party server for the third-party server to delete the personal information for the user stored on the third-party server comprises one or more of:
outputting, by the one or more processors, a set of instructions for the user to follow to send the request to the third-party server; and
automatically requesting, by the one or more processors, that the third-party server delete the personal information for the user stored on the third-party server using local user information stored on the computing device to create the request.

5. The method of claim 1, wherein requesting the personal information for the user comprises one or more of:
outputting, by the one or more processors, a set of instructions for the user to follow to send a request for the personal information for the user to the third-party server; and
automatically requesting, by the one or more processors, that the third-party server send the personal information for the user stored on the third-party server to using local user information stored on the computing device to create the request.

6. The method of claim 1, further comprising:
prior to requesting the personal information for the user, determining, by the one or more processors, an identity of an individual that initiated requesting the personal information for the user to verify that the individual is either the user or a guardian for the user.

7. The method of claim 6, wherein determining the identity of the individual comprises performing, by the one or more processors, an identity check process that includes one or more of:
a driver's license confirmation;
a photo identification card confirmation;
a username and password check;
biometric authentication;
address authentication using a global positioning system;
multi-factor authentication using one or more of an email messaging service, a text messaging service, a short messaging service, or an authentication application;
a security question check; and
a personal identification number (PIN) check.

8. The method of claim 1, further comprising:
training, by the one or more processors, an artificial intelligence model using the personal information for the user;
using, by the one or more processors, the artificial intelligence model to curate personal data stored in data objects; and
using, by the one or more processors, the artificial intelligence model to personalize a computerized avatar for the user.

9. The method of claim 1, wherein receiving the personal information for the user from the third-party server comprises one or more of:
receiving, by the one or more processors, the personal information for the user directly from the third-party server via direct transmission;
receiving, by the one or more processors, the personal information for the user via a peer-to-peer transmission;
monitoring, by the one or more processors, an email account associated with the user for an email message that includes the personal information in a body portion of the email message or as an attachment in the email message and extracting the personal information from the email message; and
receiving, by the one or more processors, the personal information for the user via an upload from a physical device, operably connected to the computing device, that includes the personal information.

10. The method of claim 1, further wherein marketing the personal information comprises:
receiving, by the one or more processors, an indication of user input providing one or more user marketing preferences;
uploading, by the one or more processors, the one or more user marketing preferences and the personal information for the user to a clearinghouse server;
removing, by the clearinghouse server, personally identifiable information from the personal information to create an anonymous profile for the user including the one or more user marketing preferences, wherein the anonymous profile is one of a plurality of anonymous profiles, and wherein each anonymous profile of the plurality of anonymous profiles is associated with a different user;
receiving, by the clearinghouse server, a request for the plurality of anonymous profiles from a marketer;
sending, by the clearinghouse server, the plurality of anonymous profiles to the marketer;
receiving, by the clearinghouse server, an indication of a subset of anonymous profiles from the plurality of anonymous profiles, wherein each anonymous profile of the subset of anonymous profiles is associated with a user that the marketer is requesting to provide advertisements to, wherein the subset of anonymous profiles includes the anonymous profile for the user;
sending, by the clearinghouse server, the personally identifiable information for each of subset of anonymous profiles, including the personally identifiable information for the anonymous profile of the user, to the marketer with a request for a payment;
receiving, by the clearinghouse server, the payment from the marketer; and
distributing, by the clearinghouse server, at least a portion of the payment to a payment account of the user and to a payment account of each user associated with an anonymous profile of the subset of anonymous profiles.

11. The method of claim 10, wherein the payment account of the user comprises a bank account or an online wallet provided by the clearinghouse server.

12. The method of claim 10, wherein the one or more user marketing preferences comprise one or more of:
a list of specific marketers that the user wishes to market their personal data to;
a list of specific marketers that the user wishes to hide their personal data from;
a list of genres of marketers that the user wishes to market their personal data to;
a list of genres of marketers that the user wishes to hide their personal data from;
a limit for a number of marketers that the user wishes to sell their personal data to over a given period of time; and
a minimum price threshold that the user requires from marketers to sell their personal data.

13. The method of claim 10, wherein uploading the personal information to the clearinghouse server comprises:
removing, by the one or more processors, the personally identifiable information from the personal information for the user prior to uploading the personal information to the clearinghouse server.

14. The method of claim 1, further comprising:
monitoring, by the one or more processors, a group of one or more third-party services to determine what personal information for the user is stored on each of the third-party services of the group of one or more third-party services.

15. The method of claim 14, further comprising:
verifying, by the one or more processors and based on locally stored user information, that the personal information for the user stored on each of the third-party services of the group of one or more third-party services is accurate; and
issuing, by the one or more processors and to a first third party service of the group of one or more third-party services, a request to update any personal information on the first third party service that is inaccurate.

16. The method of claim 14, further comprising:
generating, by the one or more processors, a privacy report based on the determination of what personal information for the user is stored on each of the third-party services of the group of one or more third-party services; and
outputting, by the one or more processors, the privacy report.

17. A computing device comprising:
a memory; and
one or more processors configured to:
request personal information for a user stored on a third-party server;
receive the personal information for the user from the third-party server; and
market the personal information for the user on behalf of the user.

18. The computing device of claim 17, wherein the one or more processors are further configured to:
send a request to the third-party server for the third-party server to delete the personal information for the user stored on the third-party server; and
monitor the personal information for the user stored on the third-party server to confirm that the third-party server deleted the personal information for the user.

19. The computing device of claim 17, wherein the one or more processors being configured to market the personal information for the user comprises the one or more processors being configured to:
receive an indication of user input providing one or more user marketing preferences;
upload the one or more user marketing preferences and the personal information for the user to a clearinghouse server;
cause one or more processors of the clearinghouse server to remove personally identifiable information from the personal information to create an anonymous profile for the user including the one or more user marketing preferences, wherein the anonymous profile is one of a plurality of anonymous profiles, and wherein each anonymous profile of the plurality of anonymous profiles is associated with a different user;
cause the one or more processors of the clearinghouse server to receive a request for the plurality of anonymous profiles from a marketer;
cause the one or more processors of the clearinghouse server to send the plurality of anonymous profiles to the marketer;
cause the one or more processors of the clearinghouse server to receive an indication of a subset of anonymous profiles from the plurality of anonymous profiles, wherein each anonymous profile of the subset of anonymous profiles is associated with a user that the marketer is requesting to provide advertisements to, wherein the subset of anonymous profiles includes the anonymous profile for the user;
cause the one or more processors of the clearinghouse server to send the personally identifiable information for each of subset of anonymous profiles, including the personally identifiable information for the anonymous profile of the user, to the marketer with a request for a payment;
cause the one or more processors of the clearinghouse server to receive the payment from the marketer; and
cause the one or more processors of the clearinghouse server to distribute at least a portion of the payment to a payment account of the user and to a payment account of each user associated with an anonymous profile of the subset of anonymous profiles.

20. A non-transitory computer-readable storage medium comprising instructions that, when executed by one or more processors of a computing device, cause the one or more processors to:
request personal information for a user stored on a third-party server;
receive the personal information for the user from the third-party server; and
market the personal information for the user on behalf of the user.
